(19) United States
(12) Patent Application Publication
(10) Pub. No.: US 2004/0114026 A1
(43) Pub. Date: Jun. 17, 2004

(54) Image forming apparatus

(76) Inventors: Hirohito Kondo, Osaka (JP); Hideki Ishida, Osaka (JP); Eiji Tatsumi, Osaka (JP)

Correspondence Address: SMITH, GAMBRELL & RUSSELL, LLP, 1850 M STREET, N.W., SUITE 800, WASHINGTON, DC, 20036, US

(21) Appl. No.: 10/731,010

(22) Filed: Dec. 10, 2003

(30) Foreign Application Priority Data
Dec. 12, 2002 (JP) 2002-360640
Dec. 12, 2002 (JP) 2002-360661
Dec. 12, 2002 (JP) 2002-360673

(51) Int. Cl. B41J 2/45

(52) U.S. Cl. 347/238

(57) ABSTRACT

Such an image forming device is supplied as can prevent uneven density of images and enhance image quality, including an LED array control unit that controls driving of an LED print head and a selective-information-data feeding unit that feeds information data corresponding information selected from inherent selective information. The control unit is provided with a characteristic-data memory unit that memorizes a plurality of characteristic data concerning each of LED elements forming the LED array, a driving-current-correction-data calculation unit, an image-signals processing unit and an image-data correction calculation unit. The current-correction-data calculation unit reads out characteristic data from the characteristic-data memory unit, receives selected information data from the data feeding unit and calculates driving current correction data based on these data. The image-data correction calculation unit corrects image data fed from the signals processing unit by using current correction data and feeds the corrected image data to the print head.

### BACKGROUND OF THE INVENTION

1. Field of the Invention

The present invention relates to an image forming apparatus employing an LED (Light Emitting Diode) print head as an exposing measure, such as an electro-photographic printer, a facsimile apparatus, a copier and the like.

2. Description of the Prior Art

In recent years, an electro-photographic image forming apparatus employing an LED array as a measure for recording an image by exposure has been attracted attention, in order to miniaturize and simplify the apparatus. In this electro-photographic image forming apparatus, an LED print head used for exposure of a photoreceptor includes an LED array which is formed by placing a plurality of LED elements in a line, and thereby can choose the LED elements so as to make them emit light individually, based on image data.

However, it is impossible to manufacture a plurality of LED elements that forms the LED array in such a manner that light-emitting characteristic thereof is uniform. Therefore, although the same amount of electric current is applied to all the LED elements, light quantity thereof differs, depending on each of the LED elements, thereby causing variations in light quantity among the LED elements. As a result, image density becomes uneven.

Therefore, such LED print heads are proposed as, wherein, correction is made in order to make the light quantity of the LED elements uniform. For example, the following LED print heads are proposed, wherein: for the purpose of standardizing light-emitting output of an LED printer and enhancing printing quality thereof, electric current to be supplied to each of the LED elements is controlled and the light quantity thereof is made uniform, by trimming with laser beam so as to adjust a resistance value. (For example, see Japanese Laid-Open Patent Application No. H5-4376 (pages 3 and 4, FIGS. 6 through 8.)) Moreover, another example is proposed, wherein: for the purpose of requiring no adjustment in installing an LED print head having variations in light quantity or requiring no adjustment in replacing the LED print head, correction data that make light-emitting amount of the LED elements uniform are obtained in advance; an ROM saving the relevant correction data in the LED print head is provided; and each of the LED elements is lighted at the time of printing by using the correction data. (For example, see Japanese Laid-Open Patent Application No. H5-50653 (pages 4 and 4, FIG. 1).)

However, since light image data emitted from the LED elements are formed into a latent image on a photoreceptor through a lens array, the image forming apparatuses including the above conventional LED print heads have the diameter of dots formed therein differ according to each of the LED elements, due to variation in optical characteristics of the lens array and the like, although the light quantity of the LED elements is made uniform. Therefore, it has been impossible to standardize distribution of the light quantity, thereby causing an inconvenience that vertical streaks occur on images. For example, as shown in FIG. 10, although the light quantities of both LED elements of an LED element a′ and an LED element b′ are the same, the dot diameters Sₐ′ and S_{b}′ of both LED elements in development threshold values are different (Sₐ′<S_{b}′). Therefore, the LED element b′ having a larger dot diameter in the development threshold value has larger latent image dots and thereby is expressed in dark in the image.

Moreover, image forming apparatuses are provided with various screens used for special image processing, toners of various colors used for color printing and the like, all of which can be set optionally. However, screens, toners and the like that are inherent to the image forming apparatuses have properties that are different from each other. Therefore, simply making the light quantity of the LED elements uniform will cause a difference in the image quality among images, depending on each of the screens, toner colors and the like.

Furthermore, in image forming apparatuses, properties of LED elements, photoreceptors, toners and the like vary or get deteriorated in accordance with a change due to ageing in application environments such as temperature and humidity and in accordance with a change due to ageing in the number of usage and the like. As a result, light quantity of the LED elements, electrostatic charging characteristic of photoreceptors or charging characteristic of toners will change. In consequence, since the image quality changes as time passes by, it is impossible to overcome the change in the image quality due to aging simply by standardizing the light quantity of the LED elements.

### SUMMARY OF THE INVENTION

An object of the present invention is to provide an image forming apparatus that can restrain uneven density of images and improve image quality thereof.

To achieve the above object, according to one aspect of the present invention, in an image forming apparatus provided with an LED print head, which includes an LED array composed of a plurality of LED elements whose lighting is controlled according to image data and a driving circuit for driving the plurality of LED elements, and an LED array controller for controlling driving of the LED print head, the image forming apparatus is further provided with a selective-information data feeder for storing information data corresponding to different sets of selective information inherent to the image forming apparatus and for feeding out information data corresponding to a selected item of the selective information, and the LED array controller is provided with a characteristic data memory for storing a plurality of sets of characteristic data each relating to one of the plurality of LED elements and a driving current correction data calculator for reading out the characteristic data from the characteristic data memory while receiving the information data from the selective-information data feeder in order to calculate, based on the characteristic data and the information data, driving current correction data for each of the plurality of LED elements.

Here, preferably, the different sets of selective information correspond to a plurality of screens with different characteristics, or correspond to a plurality of toner colors.

With this configuration, the driving current correction data for the individual LED elements is calculated from the characteristic data relating to the individual LED elements, which causes uneven density in the produced image, and the information data corresponding to a particular set of selective information, which affects the image quality of the produced image, and the individual LED elements are lit on the basis of the thus calculated driving current correction data. This makes it possible to accurately cancel differences in display density among the individual LED elements constituting the LED array and thereby obtain less uneven density in the produced image. Moreover, it is possible to efficiently reduce the appearance of vertical streaks in the produced image.

To achieve the above object, according to another aspect of the present invention, in an image forming apparatus provided with an LED print head, which includes an LED array composed of a plurality of LED elements whose lighting is controlled according to image data and a drive circuit for driving the plurality of LED elements, and an LED array controller for controlling driving of the LED print head, the image forming apparatus is further provided with a detected data feeder for detecting time-related variation in the image forming apparatus in order to feed out detected data, and the LED array controller is provided with a characteristic data memory for storing a plurality of sets of characteristic data each relating to one of the plurality of LED elements and a drive current correction data calculator for reading out the characteristic data from the characteristic data memory while receiving the detected data from the detected data feeder in order to calculate, based on the characteristic data, drive current correction data for each of the plurality of LED elements and increase or decrease the drive current correction data according to the detected data.

Here, preferably, the detected data feeder detects the atmospheric temperature or humidity inside the image forming apparatus and feeds out the temperature or humidity as the detected data, or detects the number of sheets of paper on which the image forming apparatus has formed an image and feeds out the number as the detected data. Alternatively, the detected data feeder may detect the developing bias potential or the dark and light potentials in the image forming apparatus and feed out the developing bias voltage or the dark and light potentials as the detected data.

With this configuration, the driving current correction data for the individual LED elements is calculated from the characteristic data relating to the individual LED elements, which causes uneven density in the produced image, and the thus calculated driving current correction data is increased or decreased according to detected data of time-related variations that affect the time-related variation of the quality of the produced image so that the individual LED elements are lit on the basis of the thus increased or decreased driving current correction data. This makes it possible to accurately cancel differences in display density among the individual LED elements constituting the LED array and thereby obtain less uneven density in the produced image. Moreover, it is possible to efficiently reduce the appearance of vertical streaks in the produced image.

To achieve the above object, according to another aspect of the present invention, in an image forming apparatus provided with an LED print head, which includes an LED array composed of a plurality of LED elements whose lighting is controlled according to image data and a drive circuit for driving the plurality of LED elements, and an LED array controller for controlling driving of the LED print head, the image forming apparatus is further provided with a paper image data feeder for reading an image formed by the image forming apparatus on a sheet of paper output therefrom in order to feed out paper image data, and the LED array controller is provided with a characteristic data memory for storing a plurality of sets of characteristic data each relating to one of the plurality of LED elements and a drive current correction data calculator for reading out the characteristic data from the characteristic data memory while receiving the paper image data from the paper image data feeder in order to calculate, based on the characteristic data, drive current correction data for each of the plurality of LED elements and increase or decrease the drive current correction data according to the paper image data.

Here, preferably, the paper image data feeder includes an image sensor for reading the image formed on the sheet of paper output from the image forming apparatus.

Alternatively, in an image forming apparatus provided with an LED print head, which includes an LED array composed of a plurality of LED elements whose lighting is controlled according to image data and a drive circuit for driving the plurality of LED elements, and an LED array controller for controlling driving of the LED print head, wherein the image forming apparatus is further provided with a toner image data feeder for reading a toner image formed on an image-carrying member by the image forming apparatus in order to feed out toner image data, and the LED array controller is provided with a characteristic data memory for storing a plurality of sets of characteristic data each relating to one of the plurality of LED elements and a drive current correction data calculator for reading out the characteristic data from the characteristic data memory while receiving the toner image data from the toner image data feeder in order to calculate, based on the characteristic data, drive current correction data for each of the plurality of LED elements and increase or decrease the drive current correction data according to the toner image data.

Here, preferably, the image-carrying member is a photoconductor or a transport belt. Moreover, preferably, the toner data feeder includes an image sensor for reading the toner image formed on the image-carrying member.

With this configuration, the driving current correction data for the individual LED elements is calculated from the characteristic data relating to the individual LED elements, which causes uneven density in the produced image, and the thus calculated driving current correction data is increased or decreased according to the paper image data or toner image data that is reflected in the time-related variation of the quality of the produced image so that the individual LED elements are lit on the basis of the thus increased or decreased driving current correction data. This makes it possible to accurately cancel differences in display density among the individual LED elements constituting the LED array and thereby obtain less uneven density in the produced image. Moreover, it is possible to efficiently reduce the appearance of vertical streaks in the produced image.

Preferably, the LED array controller is further provided with a drive current correction data memory for reading out the drive current correction data calculated and increased or decreased by the drive current correction data calculator and for storing the drive current correction data thus read out. The reason is that, even when it takes a long time for the driving current correction data calculator to calculate the driving current correction data, if previously calculated driving current correction data is stored in the driving current correction data memory, it is possible to correct the image data more quickly.

### BRIEF DESCRIPTION OF THE DRAWINGS

This and other objects and features of the present invention will become clear from the following description, taken in conjunction with the preferred embodiments with reference to the accompanying drawings in which:

FIG. 1 is a simplified schematic diagram showing the entire construction of an image forming apparatus common to embodiments of the present invention;

FIG. 2 is a schematic view showing a simplified construction of an LED array exposure device in an image forming apparatus common to embodiments of the present invention;

FIG. 3 is a schematic view showing an LED array exposure device installed to an image forming apparatus;

FIG. 4 is a block diagram showing the construction of an LED array control unit in an image forming apparatus according to a first embodiment of the present invention;

FIG. 5 is a block diagram showing the construction of a driving circuit of an LED print head of an image forming apparatus common to the embodiments of the present invention;

FIG. 6 is a flow chart showing a procedure for lighting control of LED elements of the image forming apparatus according to the first embodiment;

FIG. 7 is a block diagram showing the construction of an LED array control unit in an image forming apparatus according to a second embodiment of the present invention;

FIG. 8 is a flow chart showing a procedure for lighting control of LED elements of the image forming apparatus according to the second embodiment;

FIG. 9 is a block diagram showing the construction of an LED array control unit in an image forming apparatus according to a third embodiment of the present invention;

FIG. 10 is a flow chart showing a procedure for lighting control of LED elements of the image forming apparatus according to the third embodiment;

FIG. 11 is a block diagram showing the construction of an LED array control unit in an image forming apparatus according to a fourth embodiment of the present invention;

FIG. 12 is a flow chart showing a procedure for lighting control of LED elements of the image forming apparatus according to the fourth embodiment;

FIG. 13 is a block diagram showing the construction of an LED array control unit in an image forming apparatus according to a fifth embodiment of the present invention;

FIG. 14 is a flow chart showing a procedure for lighting control of LED elements of the image forming apparatus according to the fifth embodiment;

FIG. 15 is a block diagram showing the construction of an LED array control unit in an image forming apparatus according to a sixth embodiment of the present invention;

FIG. 16 is a flow chart showing a procedure for lighting control of LED elements of the image forming apparatus according to the sixth embodiment;

FIG. 17 is a block diagram showing the construction of an LED array control unit in an image forming apparatus according to a seventh embodiment of the present invention;

FIG. 18 is a block diagram showing the construction of an LED array control unit in an image forming apparatus according to an eighth embodiment of the present invention;

FIGS. 19A and 19B are diagrams showing the relationship between the exposure intensity and the beam diameter in development threshold value of LED elements of the image forming apparatus according to the embodiments of the present invention; and

FIG. 20 is a diagram showing the relationship between the contrast of density and the beam diameter in the development threshold value of the LED elements of the conventional image forming apparatuses.

### DESCRIPTION OF THE PREFERRED EMBODIMENTS

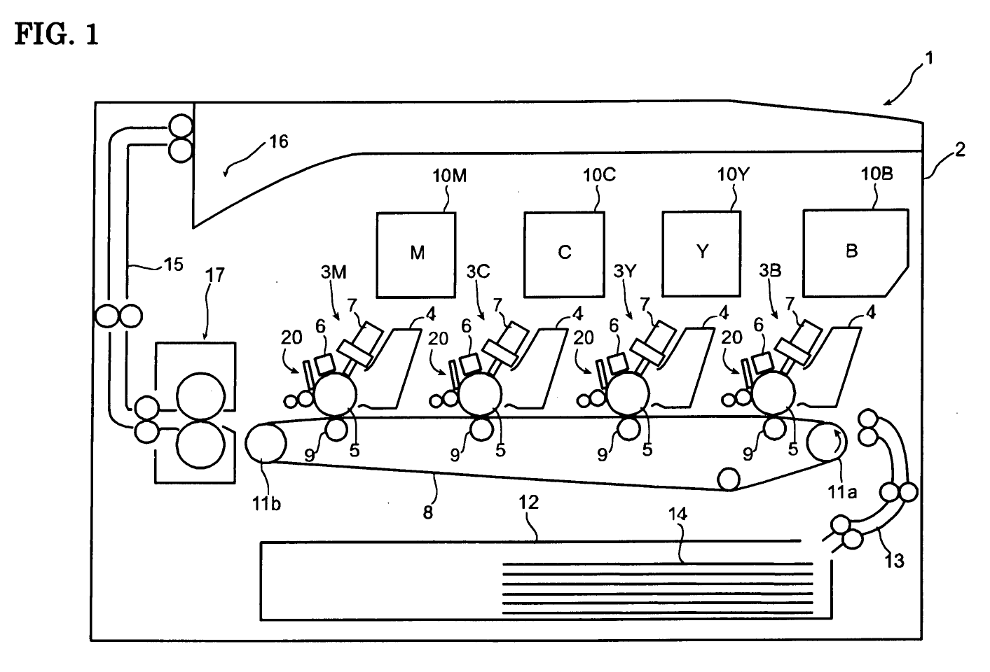

Hereinafter, embodiments of the present invention will be described with reference to the drawings. FIG. 1 is a simplified schematic diagram showing the entire construction of an image forming apparatus common to embodiments of the present invention. In an image forming apparatus shown in FIG. 1, reference numeral 1 represents a color printer as an example of an image forming apparatus. The color printer 1 comprises a housing 2, an image forming unit for black 3B, an image forming unit for yellow 3Y, an image forming unit for cyan 3C, an image forming unit for magenta 3M, toner hoppers 10B, 10Y, 10C and 10M respectively for each of the aforementioned colors, a paper feed cassette 12 for storing a plurality of papers 14, a paper feed guide 13, transport belt driving rollers 11a and 11b, a transport belt 8, image transfer rollers 9, a fusing unit 17, a paper feed-out guide 15, and a paper feed-out area 16. In addition, each of the image forming units 3B, 3Y, 3C and 3M for each color comprises a developing unit 4, a photoreceptor 5 as an image-carrying substance, a main charging unit 6, an LED print head 7, and a cleaning unit 20.

In the color printer 1, an electrostatic latent image is formed by the LED print head 7 on the photoreceptor 5 that has been charged by the main charging unit 6. Then, a toner image is developed by the developing unit 4 so that a visible image is formed. This process is performed for each of the above colors of black, yellow, cyan and magenta. The paper 14 fed from the paper feed cassette 12 is guided through the paper feed guide 13 and absorbed onto an upper face of the transport belt 8 which is rotating in a counterclockwise direction, and when the paper 14 passes right under each of the image forming units 3B, 3Y, 3C and 3M for each color, a toner image in each color is transferred onto the paper 14 one after another by the transfer roller 9. Toners in four colors forming a full-color image on the paper 14 in this way are fused when the paper 14 passes through the fusing unit 17. After that, the paper 14 is fed out into the paper feed-out area 16, guided by the paper feed-out guide 15.

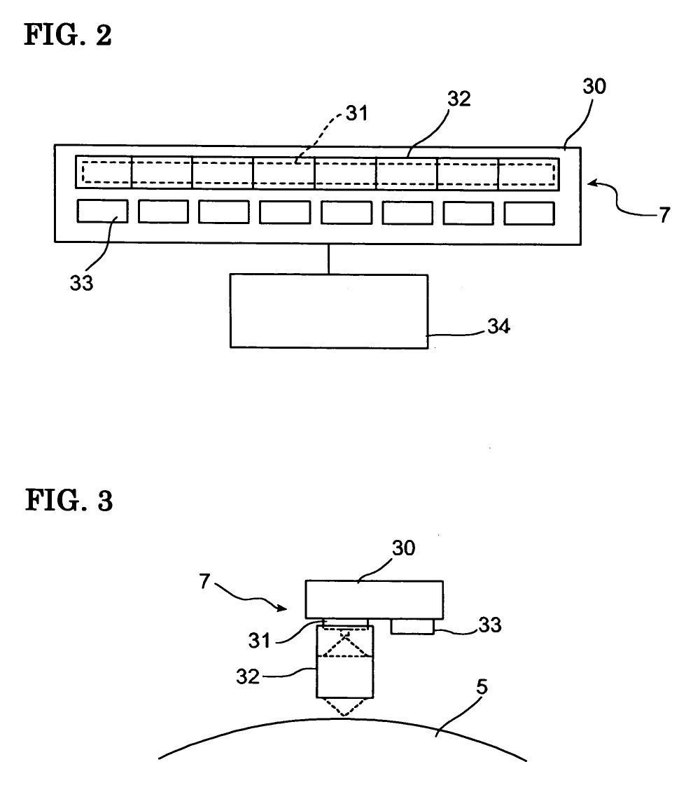

Next, the LED print head 7 installed to the above-mentioned color printer 1 is described with reference to FIG. 2. FIG. 2 is a schematic diagram showing a simplified construction of an LED array print head in an image forming apparatus common to the embodiments of the present invention. In FIG. 2, the LED print head 7 comprises a LED array including a plurality of LED's laid in line on a substrate 30 having wiring and controlled in lighting in accordance with image data, a lens array 32 arranged over the LED array 31 so as to form a full-size erect image, and a driving circuit 33 that drives a plurality of LED elements forming the LED array 31. Here, the substrate 30, the lens array 32 and the like are supported by unillustrated structural members. Additionally, an LED array control unit 34 controlling the driving of the LED print head 7 is provided externally.

FIG. 3 is a schematic view showing the LED print head 7 installed into an image forming apparatus. In FIG. 3, reference numeral 5 represents a photoreceptor having a shape of a drum. Also in the diagram, shown in broken line is how the lens array 32 receives and refracts the light emitted from LED elements so as to form an image on a surface of the drum.

As described above, each LED element is driven in accordance with image signals transmitted to the color printer 1 in FIG. 1 from an unillustrated external PC and the like and emits light. The light emitted from the LED elements forms an image as a dot on a surface of the photoreceptor 5 through the lens array 32. The image forming apparatus of the present invention is so formed as to have pixels owning larger exposure energy (or light-emitting energy of LED elements) on the photoreceptor 5 have higher density. This exposure energy (or the light-emitting energy of the LED elements) is represented by a formula: exposure intensity of the LED elements (=driving current)×lighting time (=time for supply of driving current).

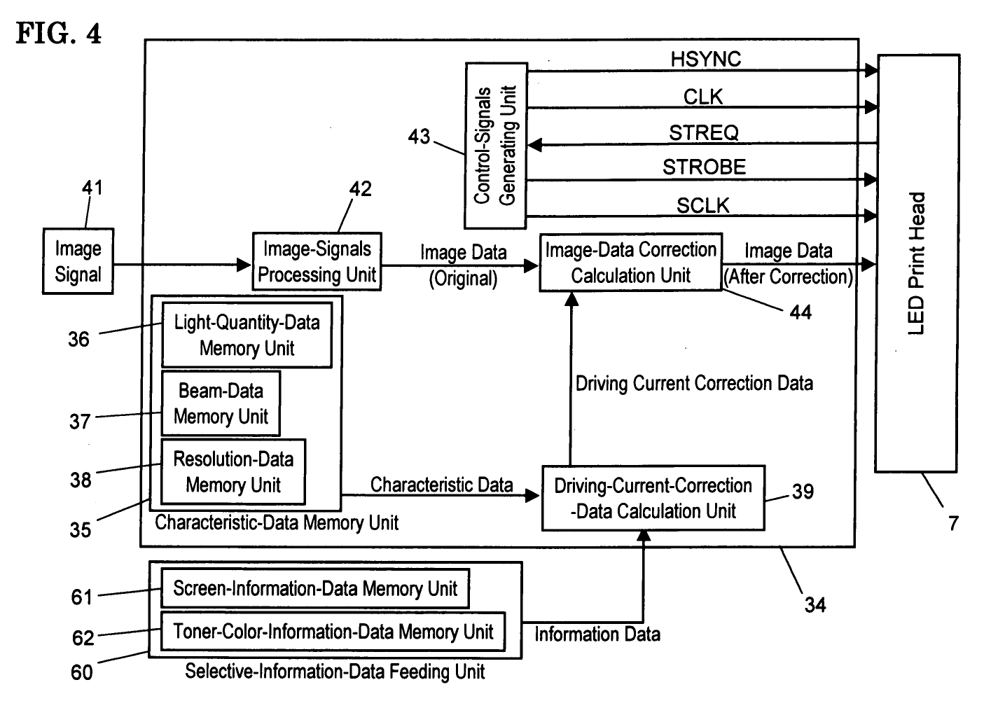

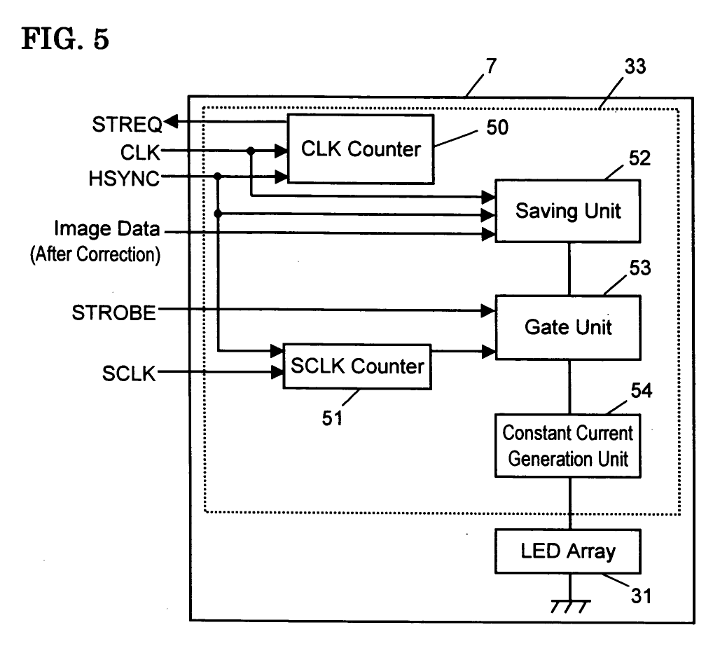

Next, by referring to FIGS. 4 and 5, performance of the LED array control unit and performance of the driving circuit of the LED print head will be described. FIG. 4 is a block diagram showing the construction of an LED array control unit of the image forming apparatus according to a first embodiment of the present invention. FIG. 5 is a block diagram showing the construction of a driving circuit of an LED print head in the image forming apparatus common to the embodiments of the present invention.

The LED array control unit 34 controls driving of the LED print head 7, comprising a characteristic-data memory unit 35, a driving-current-correction-data calculation unit 39, a image-signals processing unit 43, a control-signals generating unit 43 and an image-data correction calculation unit 44. Additionally, the LED array control unit 34 has a selective-information-data feeding unit 60 provided externally.

The image-signals processing unit 42 is a measure to perform image processing such as tone processing and the like in an appropriate manner for image signals 41 transmitted to the LED array control unit 34 from external devices such as a frame memory, a scanner and the like and to convert the image signals 41 into image data. The image data are data which show the density of pixels separated according to each of the aforementioned four colors of black, yellow, cyan and magenta, and are m-bit digital data showing driving current (light-emitting intensity) and lighting time (time for supply of driving current) of the LED elements. Image data processed by the image-signals processing unit 42 are fed to the image-data correction calculation unit 44.

The characteristic-data memory unit 35 is a measure to memorize a plurality of pre-measured characteristic data concerning each of a plurality of LED elements forming the LED array 31. For example, as shown in FIG. 4, the characteristic-data memory unit 35 comprises a light-quantity-data memory unit 36 that memorizes data on light quantity concerning each of the LED elements as characteristic data; a beam-data memory unit 37 that memorizes data concerning beams emitted from the LED elements, for example, data concerning beam diameter and beam area, as characteristic data; and a resolution-data memory unit 38 that memorizes data showing resolution of each of the LED elements, for example, Modulation Transfer Function (MTF) data, as characteristic data. The characteristic-data memory unit 35, for example, includes a Read on Memory (ROM), but may be so constructed as to include a transferable PROM (e.g. EPROM that deletes data by using ultraviolet rays or EEPROM that deletes data electrically) in order to correspond to a change in properties of individual LED elements.

The selective-information-data feeding unit 60 is provided with a screen-information-data memory unit 61 storing information data corresponding respectively to each of selective information on a plurality of screens different from each other in properties and selective information on a plurality of toner colors, that are selective information inherent to the image forming apparatus of the present invention, and is provided with a toner-color-information-data memory unit 62; extracts information data corresponding to selective information on screens and toners, which are selected by inputting from an unillustrated operation unit, from the screen-information-data memory unit 61 and the toner-color-information-data memory unit 62; and feeds to the driving-current-correction-data calculation unit 39, which will be described hereinafter in details. Representative plurality of toner colors are black, yellow, cyan and magenta.

Next, the driving-current-correction-data calculation unit 39 is connected to the characteristic-data memory unit 35 and the selective-information-data feeding unit 60, read outs each of the characteristic data memorized in the light-quantity-data memory unit 36, the beam-data memory unit 37 and the resolution-data memory unit 38, all of which are installed in the characteristic-data memory unit 35; receives information data corresponding to selective information on screens and toner colors selected and fed from the selective-information-data feeding unit 60; and calculates driving current correction data P for each of a plurality of LED elements forming the LED array 31 in accordance with a predetermined calculation formula, based on the characteristic data and the information data. The driving current correction data P calculated by the driving-current-correction-data calculation unit 39 are fed to the image-data correction calculation unit 44.

As described later, the driving current correction data P are data that are used when exposure intensity of each individual LED element is changed by changing the driving current of each individual of the individual LED elements forming the LED array 31. For example, when the driving current of a dot #1 (a first LED element) is corrected, driving current correction data Pₗ are used; and when the driving current of a dot #n (an n-th LED element) is corrected, driving current correction data Pₙ are used.

The image-data correction calculation unit 44 corrects image data fed by the image-signals processing unit 42 by using driving current correction data P fed by the driving-current-correction-data calculation unit 39. In other words, the image-data correction calculation unit 44 corrects m-bit digital data showing the driving current of each individual of the LED elements forming the LED array 31, among the image data fed by the image-signals processing unit 42, in accordance with the driving current correction data P fed by the driving-current-correction-data calculation unit 39. The image data subjected to the relevant correction are fed to the LED print head 7, as shown in FIG. 4.

A driving circuit 33 of the LED print head 7, as shown in FIG. 5, includes a CLK counter 50 that counts clock signals CLK, an SCLK counter 51 that counts strobe clock signals SCLK, a saving unit 52 that temporarily saves image data showing pixel densities after correction, a gate unit 53 that opens and closes in accordance with a logic of feeding time control signals STROBE, and a constant-current generation unit 54 that generates driving current of the LED array 31.

A driving circuit 33 of the LED print head 7 with the construction as mentioned above initiates receiving post-correction image data that are fed by being initialized by changing from high level to low level of horizontal synchronization signals HSYNC fed from the control-signals generation unit 43 and by synchronizing with the clock signal CLK input from the control-signals generation unit 43 and with the clock signal CLK.

The saving unit 52 is provided with a shift register and a latch circuit, wherein data necessary for light-emission of the LED array 31 are temporarily saved in order to convert image data fed after correction. Here, driving methods of the LED elements forming the LED print head include a static driving method that controls lighting-on and lighting-off of all LED elements simultaneously, and a dynamic driving method that divides the LED's into a plurality of blocks and controls lighting-on and lighting-off of each individual block thereof. In case of adopting the static driving method, data for all the LED elements are saved temporarily, while in case of adopting the dynamic driving method, data for one block are saved temporarily.

The CLK counter 50 determines whether or not temporary saving of image data in the saving unit 52 has been completed, based on the number of counts of clock signals CLK, and when such temporary saving is determined to have been completed, transmits a light-emitting timing control signal STREQ to the control-signals generating unit 43 so as to show that preparation is made for emitting a light.

The control-signals generation unit 43 that receives a light-emitting timing control signal STREQ sets a feeding time control signal STROBE to be at the active level (low level), and when strobe clock signals SCLK begin to be fed, the SCLK counter 51 starts counting the strobe clock signals SCLK and then the gate unit 53 is released. As a result, the LED elements forming the LED array 31 have driving current based on driving current correction data P saved in the saving unit 52 flow thereon for a period as long as light-emitting time based on the image data saved in the saving unit 52, and consequently, the photoreceptor 5 is exposed.

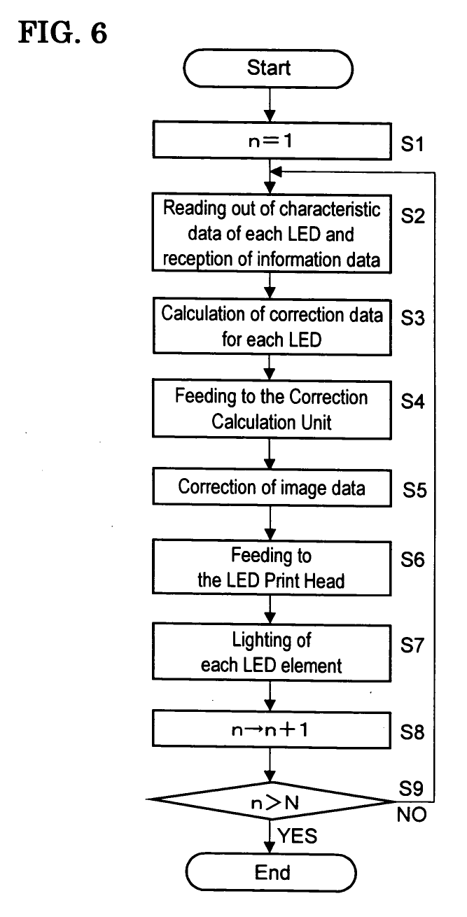

FIG. 6 is a flow chart showing a procedure for lighting control of the LED elements according to the first embodiment. In this control procedure, first of all, n=1 is set in order to make the first line of the total number of lines N targeted. (Step S1) Next, characteristic data of each of the LED elements are read out from the characteristic-data memory unit 35, receiving information data corresponding to selective information that is selected and fed from the selective-information-data feeding unit 60 (Step S2); and driving current correction data P for each of the LED elements are calculated in the driving-current-correction-data calculation unit 39. (Step S3) Then, calculated driving current correction data P are fed to the image-data correction calculation unit 44 (Step S4), and in the image-data correction calculation unit 44, image data are corrected. (Step S5) Next, corrected image data are fed to the LED print head (Step S6), and the LED elements are lighted in accordance with the corrected image data. (Step S7) Then, in order to have the next line “n” targeted, an increment of +1 is supplied to the number “n” (Step S8), checking to ensure that the number “n” does not exceed the total line number N to be printed. (Step S9) When the number “n” does not exceed the total line number N, the above processing will be repeated in the same manner for the line “n.” (Steps S2 through S9)

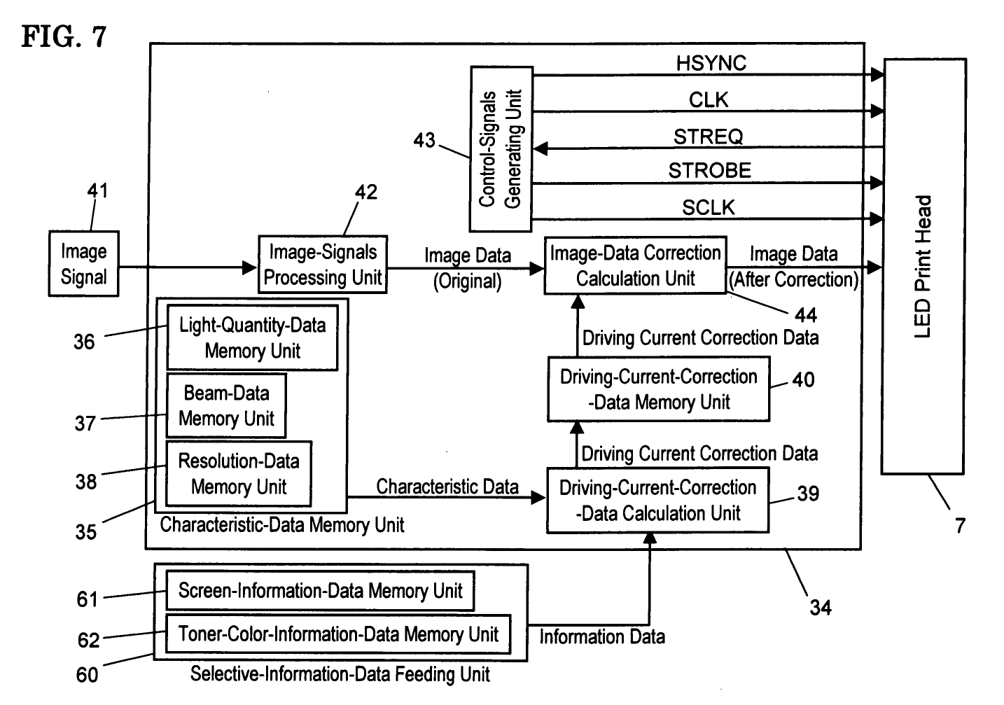

The first embodiment of the present invention is constructed in such a manner as driving current correction data P are directly fed to the image-data correction calculation unit 44 after calculated by the driving-current-correction-data calculation unit 39. However, as shown in FIG. 7, it may be so constructed as to have a driving-current-correction-data memory unit 40, which memorizes driving current correction data P calculated in the driving-current-correction-data calculation unit 39, provided thereto separately and to have the driving-current-correction-data memory unit 40 connected to the driving-current-correction-data calculation unit 39 and the image-data correction calculation unit 44. This construction will be described hereinafter as a second embodiment of the present invention.

According to the second embodiment of the present invention, the driving-current-correction-data memory unit 40 reads out driving current correction data P from the driving-current-correction-data calculation unit 39, memorizes the operating current correction data P and feeds the driving current correction data P to the image-data correction calculation unit 44. In order to cope with a change of the driving current correction data P based on a change in characteristics and the like of each of individual LED element, the driving-current-correction-data memory unit 40 is provided with, for example, a transferable PROM (e.g. EPROM that deletes data with ultraviolet rays or EEPROM that deletes data electrically) and the like.

With the above-mentioned configuration, although calculation of driving current correction data P takes a long time, it is possible to read out driving current correction data P rapidly in the image-data correction calculation unit 44 because pre-calculated driving current correction data P are memorized in the driving-current-correction-data memory unit 40. As a result, it becomes possible for the image-data correction calculation unit 44 to correct image data rapidly.

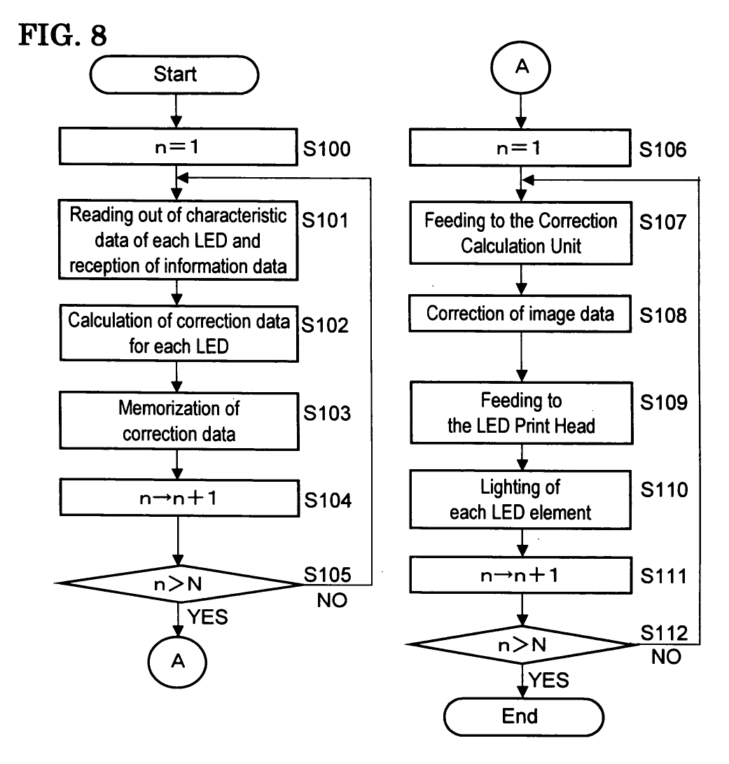

A procedure for lighting control of the LED elements is followed in accordance with the flow chart shown in FIG. 8. Namely, first of all, n=1 is set in order to make the first line of the total number of lines N targeted. (Step S100) Next, characteristic data of each of the LED elements are read out from the characteristic-data memory unit 35, receiving information data corresponding to selective information that is selected and fed from the selective-information-data feeding unit 60 (Step S101); and driving current correction data P of each of the LED elements are calculated in the driving-current-correction-data calculation unit 39. (Step S102) Then, calculated driving current correction data P are memorized in the driving-current-correction-data memory unit 40. (Step S103) Next, in order to have the next line “n” targeted, an increment of +1 is supplied to the number “n” (Step S104), checking to ensure that the number “n” does not exceed the total line number N to be printed. (Step S105). When the number “n” does not exceed the total line number N, the above processing will be repeated in the same manner for the line “n,” and the driving current correction data P will be memorized in the driving-current-correction-data memory unit 40 for all the lines. (Steps SI01 through S105)

Next, again, n=1 is set in order to have the first line of the total number of lines N targeted. (Step S106) Next, driving current correction data P memorized in the driving-current-correction-data memory unit 40 are fed to the image-data correction calculation unit 44 (Step S107), and image data are corrected in the image-data correction calculation unit 44. (Step S108) Next, corrected image data are fed to the LED print head 7 (Step S109), and the LED elements are lighted in accordance with the corrected image data. (Step SI 10) Then, in order to have the next line “n” targeted, an increment of +1 is supplied to the number “n” (Step S111), checking to ensure that the number “n” does not exceed the total line number N to be printed. (Step S112) When the number “n” does not exceed the total line number N, the above processing will be repeated in the same manner for the line “n.” (Steps S 107 through S112)

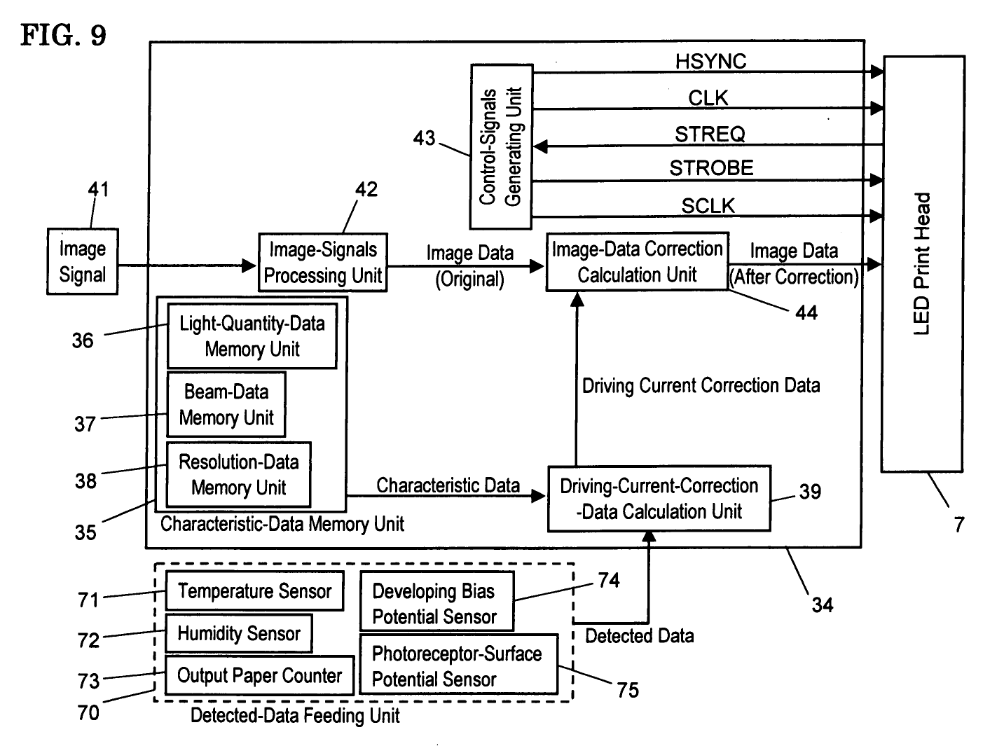

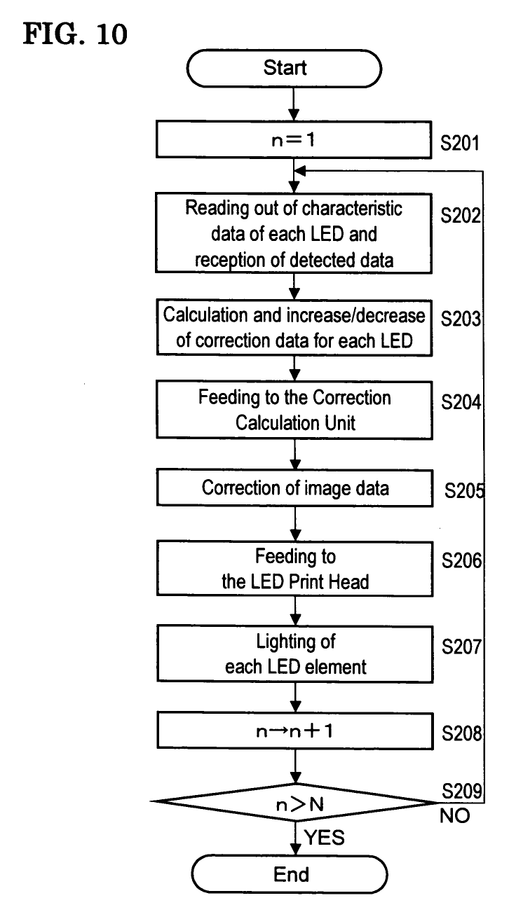

Subsequently, a third embodiment of the present invention will be described with reference to FIGS. 9 and 10. FIG. 9 is a block diagram showing the construction of an LED array control unit in an image forming apparatus according to the third embodiment. FIG. 10 is a flow chart showing a procedure for lighting control of LED elements in the image forming apparatus. In FIG. 9, parts having the same names as those in the figures of FIGS. 1 through 5 and FIG. 7 are denoted by the same reference numerals, and explanation will be omitted when repeated. This will be the same for a fourth through an eighth embodiments of the present invention that will be described later.

The third embodiment is characterized in that the selective-information-data feeding unit 60 according to the first embodiment is changed to a detected-data feeding unit 70. In other words, as shown in FIG. 9, the LED array control unit 34 is provided with a detected-data feeding unit 70 externally. The detected-data feeding unit 70 detects a change in the image forming apparatus due to aging that gives an influence on a fluctuation of image quality due to ageing, in other words, which means a change in light quantity of the LED elements and in electrostatic charging characteristic of the photoreceptor; and feeds the detected data to the driving-current-correction-data calculation unit 39. The detected-data feeding unit 70 has the following applied thereto, including: a temperature sensor 71 which detects ambient temperatures in the apparatus and feeds them as detected data; a humidity sensor 72 which detects humidity in the apparatus and feeds it as a detected datum; an output paper counter 73 which detects the number of output paper having an image formed thereon and feeds the total number of output paper and the number of paper continuously output as detected data; a developing bias potential sensor 74 which detects developing bias potentials and feeds them as detected data; and a photoreceptor-surface potential sensor 75 which detects dark and light potentials of a surface of the photoreceptor and feeds them as detected data; each of which is installed at an appropriate location in an appropriate manner inside the apparatus.

According to the third embodiment of the present invention, the driving-current-correction-data calculation unit 39 is connected to the characteristic-data memory unit 35 and the detected-data feeding unit 70; reads out each of the characteristic data memorized in the light-quantity-data memory unit 36, the beam-data memory unit 37. and the resolution-data memory unit 38, all of which are mounted in the characteristic-data memory unit 35; receives detected data fed from the detected-data feeding unit 70; calculates driving current correction data P for each of a plurality of LED elements forming the LED array 31, based on the characteristic data; and increases or decreases the driving current correction data P in accordance with the detected data. Then, the calculated and increased/decreased driving current correction data P are fed to the image-data correction calculation unit 44.

Next, a procedure for lighting control of the LED elements according to the third embodiment will be explained by referring to FIG. 10. First of all, the same as the first embodiment, n=1 is set to make the first line of the total number of lines N targeted. (Step S201) Next, characteristic data of each of the LED elements are read out from the characteristic-data memory unit 35, receiving detected data fed from the detected-data feeding unit 70 (Step S202), and driving current correction data P for each of the LED elements are calculated and increased or decreased in the driving-current-correction-data calculation unit 39. (Step S203) Next, calculated and increased/decreased driving current correction data P are fed to the image-data correction calculation unit 44. (Step S204) Hereafter, a procedure including the steps S205 through S209 corresponding to the steps S5 through S9 of the first embodiment (See FIG. 6.) will be followed sequentially.

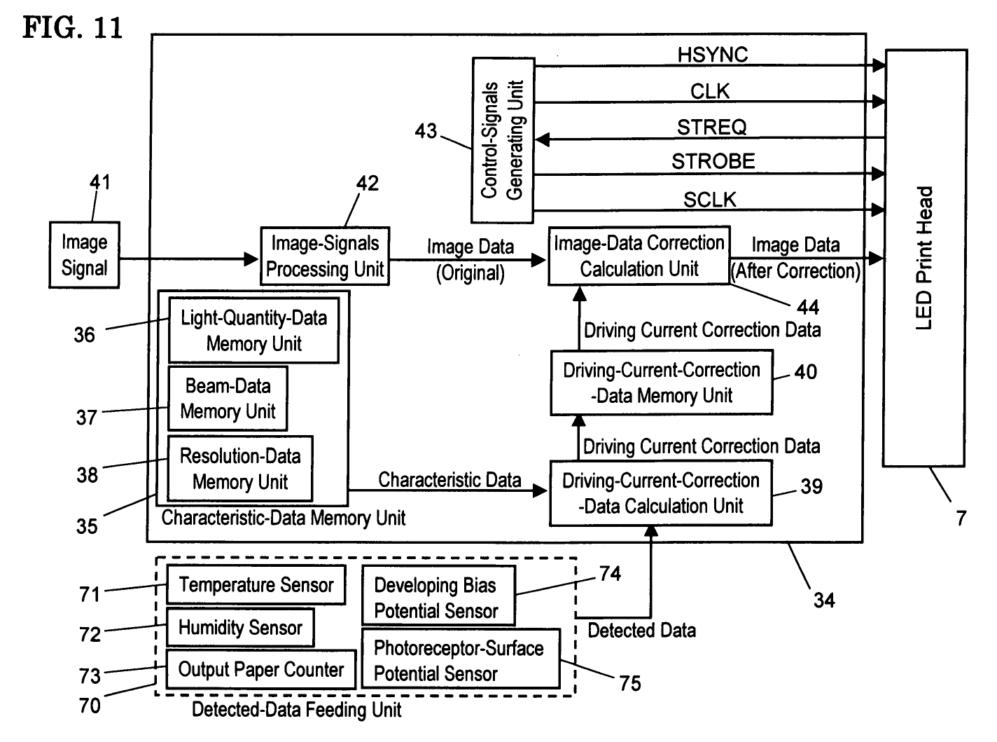

The same as the first embodiment, the third embodiment is so constructed as to have driving current correction data P directly fed to the image-data correction calculation unit 44 after the driving current correction data P are calculated and increased/decreased in the driving-current-correction-data calculation unit 39. However, the same as the relationship between the first and the second embodiments, as shown in FIG. 11, a fourth embodiment of the present invention is separately provided with a driving-current-correction-data memory unit 40 that memorizes driving current correction data P calculated and increased/decreased in the driving-current-correction-data calculation unit 39, and has the driving-current-correction-data memory unit 40 connected to the driving-current-correction-data calculation unit 39 and to the image-data correction calculation unit 44.

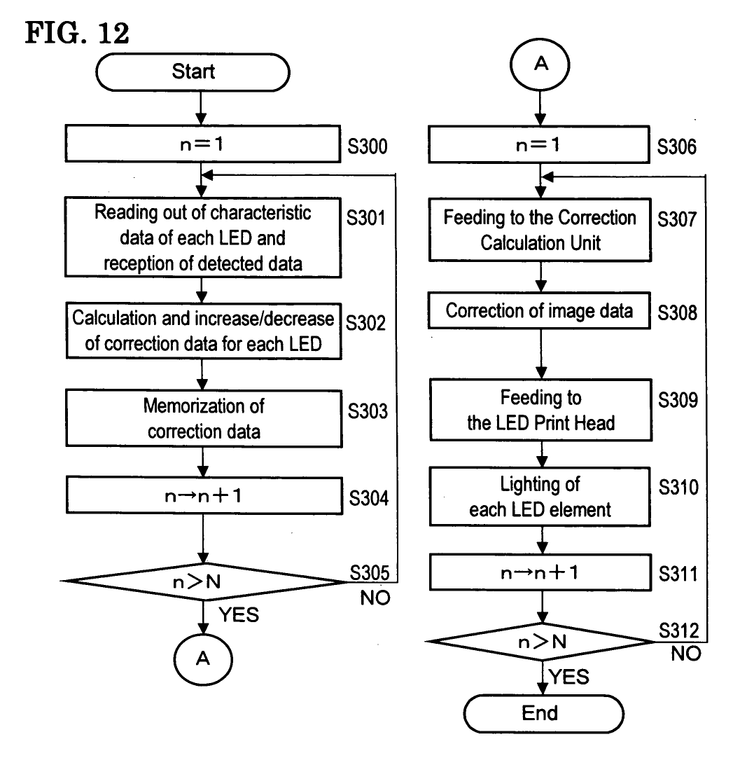

A procedure for lighting control of the LED elements according to the fourth embodiment will be explained by referring to FIG. 12. The same as the second embodiment, n=1 is set to make the first line of the total number of lines N targeted. (Step S300) Next, characteristic data of each of the LED elements are read out from the characteristic-data memory unit 35, receiving detected data fed from the detected-data feeding unit 70 (Step S301); and driving current correction data P for each of the LED elements are calculated and increased or decreased in the driving-current-correction-data calculation unit 39. (Step S302) Next, calculated and increased/decreased driving current correction data P are memorized in the-driving-current-correction-data memory unit 40. (Step 303) Then, after that, a procedure including the steps S304 through S312 corresponding to the steps S104 through S112 of the second embodiment (See FIG. 8.) will be followed sequentially.

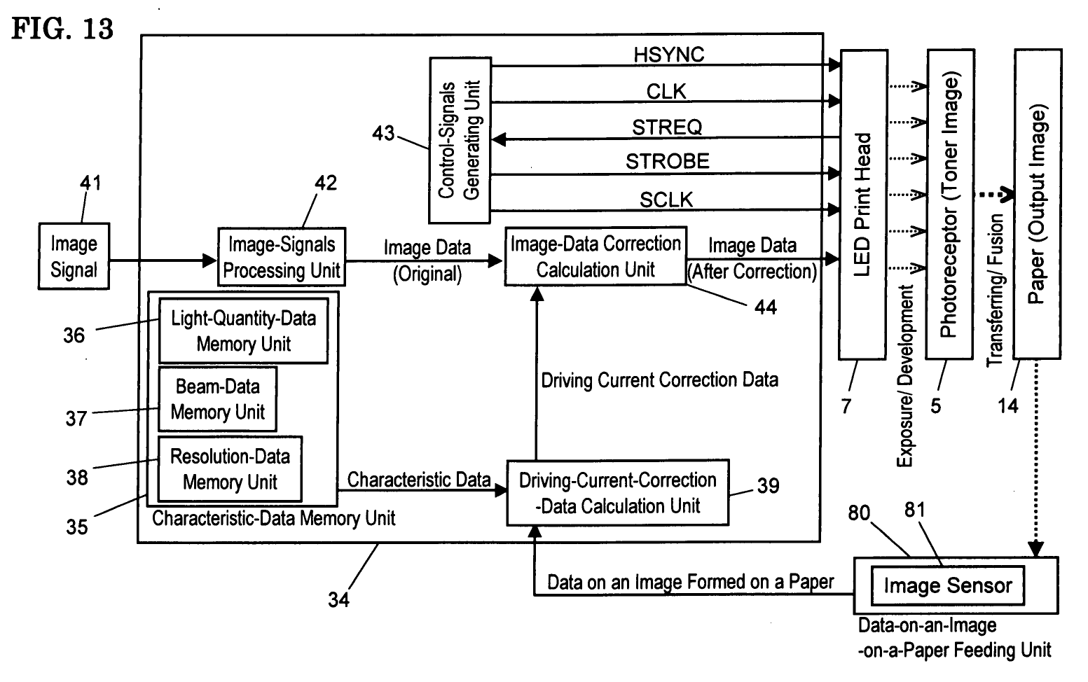

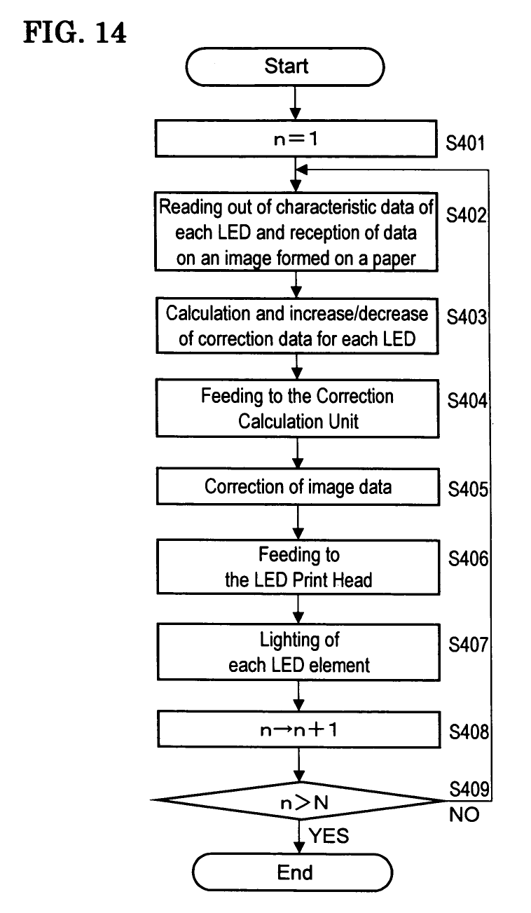

Next, a fifth embodiment of the present invention will be described by referring to FIGS. 13 and 14. FIG. 13 is a block diagram showing the construction of an LED array control unit of an image forming apparatus according to the fifth embodiment. FIG. 14 is a flow chart showing a procedure for lighting control of the LED elements in the image forming apparatus.

The fifth embodiment is characterized in that the selective-information-data feeding unit 60 according to the first embodiment is changed to a data-on-an-image-on-a-paper feeding unit 80. In other words, as shown in FIG. 13, an LED array control unit 34 is provided with the data-on-an-image-on-a-paper feeding unit 80 externally. The data-on-an-image-on-a-paper feeding unit 80 reads an image formed on an output paper 14 by the image forming apparatus, that is reflected in a fluctuation of image quality due to ageing, in other words, a change in the light quantity of LED elements, in the electrostatic charging characteristic of a photoreceptor and in the charging characteristic of a toner; and feeds data on an image formed on a paper mainly showing degree of uneven density of the image to the driving-current-correction-data calculation unit 39. The data-on-an-image-on-a-paper feeding unit 80 has an image sensor 81 applied thereto, which scans and reads an image formed on an output paper. The image sensor 81 is so mounted as to be in close proximity to the paper 14, facing to it, which is immediately before passing through a fusing unit 17 (See FIG. 1.) after transferring is finished.

According to the fifth embodiment of the present invention, a driving-current-correction-data calculation unit 39 is connected to a characteristic-data memory unit 35 and to a data-of-an-image-on-a-paper feeding unit 80, reads out characteristic data memorized in a characteristic-data memory unit 35, receives data on an image formed on a paper fed from the data-of-an-image-on-a-paper feeding unit 80, calculates driving current correction data P for each of a plurality of LED elements forming an LED- array 31 based on characteristic data, and increases or decreases the driving current correction data P in accordance with data of an image formed on a paper. Then, the calculated and increased/decreased driving current correction data P are fed to the image-data correction calculation unit 44.

Subsequently, a procedure for lighting control of the LED elements according to the fifth embodiment will be explained by referring to FIG. 14. First of all, the same as the first embodiment, n=1 is set to make the first line of the total number of lines N targeted. (Step S401) Next, characteristic data of each of the LED elements are read out from the characteristic-data memory unit 35, receiving data on an image formed on a paper fed from the data-of-an-image-on-a-paper feeding unit 80 (Step S402); and driving current correction data P for each of the LED elements are calculated and increased or decreased in the driving-current-correction-data calculation unit 39. (Step S403) Then, the calculated and increased/decreased driving current correction data P is fed to the data-of-an-image-on-a-paper correction calculation unit 44. (Step S404) Hereafter, a procedure including the steps S405 through S409 corresponding to the steps S5 through S9 of the first embodiment (See FIG. 6.) will be followed sequentially.

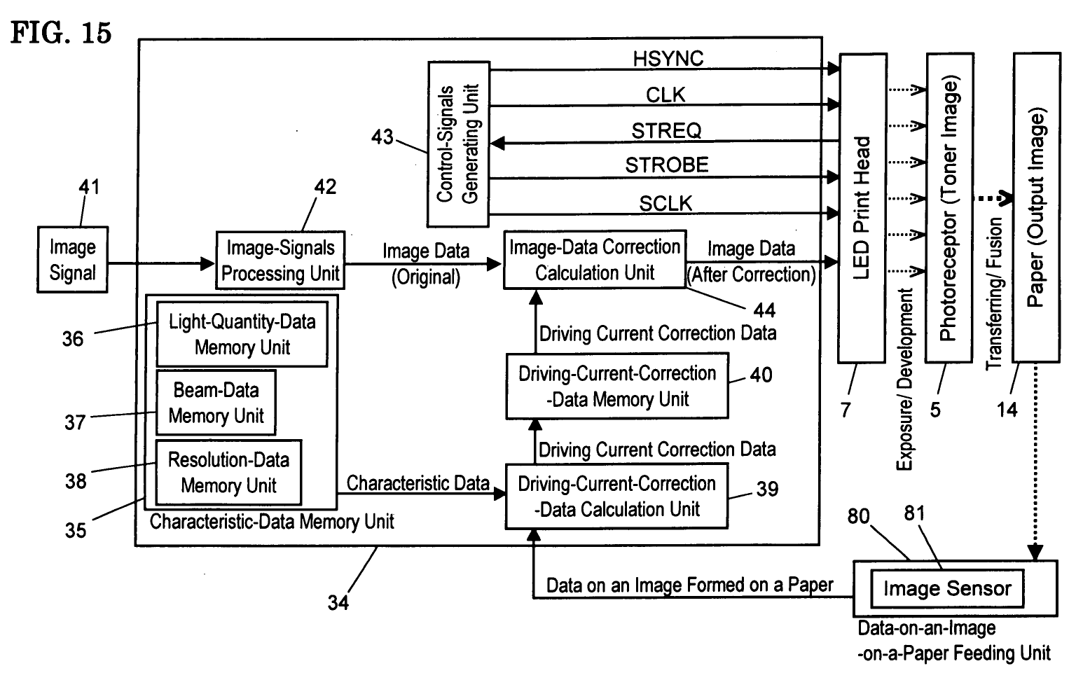

The same as the first embodiment, the fifth embodiment is so constructed as to have driving current correction data P directly fed to the image-data correction calculation unit 44 after the driving current correction data P are calculated and increased/decreased in the driving-current-correction-data calculation unit 39. However, according to a sixth embodiment of the present invention, the same as the relationship between the first and the second embodiments (corresponding to the relationship between the third and the fourth embodiments), as shown in FIG. 15, a driving-current-correction-data memory unit 40 is provided separately, that memorizes driving current correction data P calculated and increased/decreased in the driving-current-correction-data calculation unit 39, and the driving-current-correction-data memory unit 40 is connected to the driving-current-correction-data calculation unit 39 and to the image-data correction calculation unit 44.

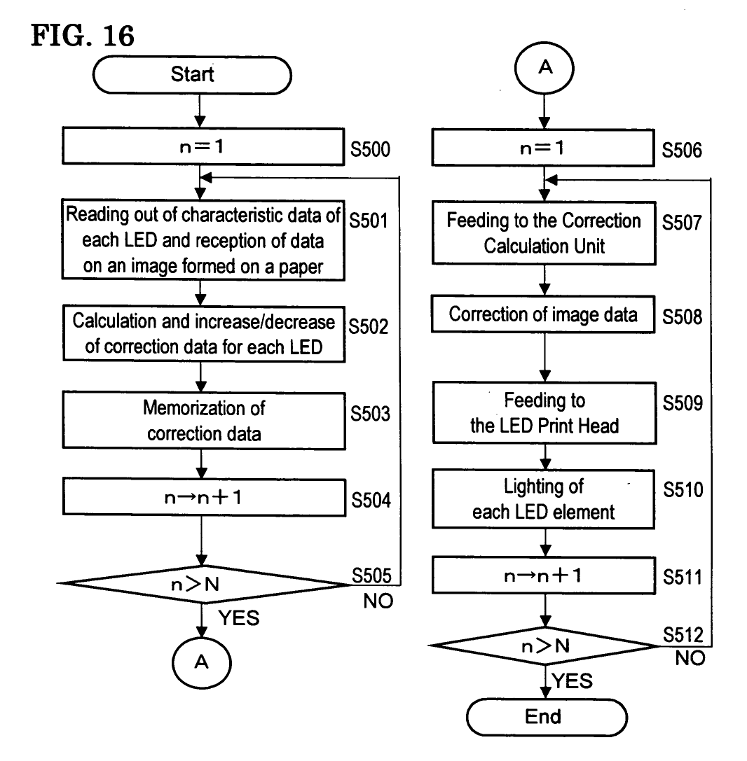

A procedure for lighting control of the LED elements according to the sixth embodiment will be explained by referring to FIG. 16. First of all, the same as the second embodiment, n=1 is set to make the first line of the total number of lines N targeted. (Step S500) Next, characteristic data of each of the LED elements are read out from the characteristic-data memory unit 35, receiving data of an image formed on a paper fed from the data-of-an-image-on-a-paper feeding unit 80 (Step S501), and driving current correction data P for each of the LED elements are calculated and increased or decreased in the driving-current-correction-data calculation unit 39. (Step S502) Next, calculated and increased/decreased driving current correction data P are memorized in the driving-current-correction-data memory unit 40. (S503). Then, after that, a procedure including the steps S504 through S512 corresponding to the steps S104 through S112 of the second embodiment (See FIG. 8.) will be followed sequentially.

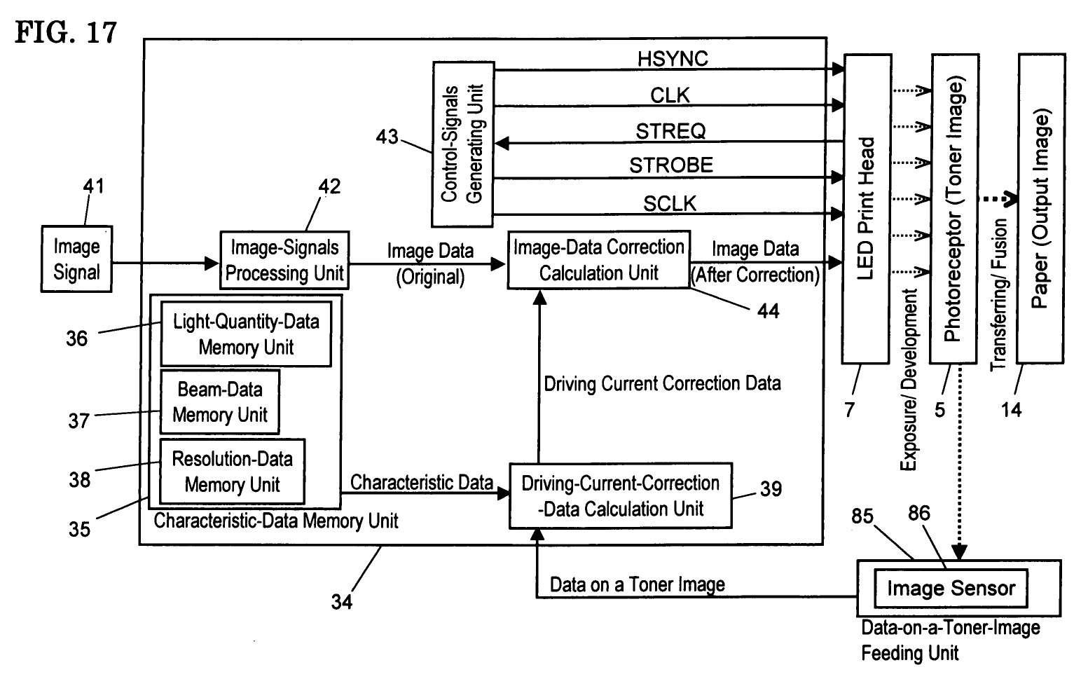

Next, a seventh embodiment of the present invention will be described by referring to FIG. 17. FIG. 17 is a block diagram showing the construction of an LED array control unit in an image forming apparatus according to the seventh embodiment.

The seventh embodiment is characterized in that the data-of-an-image-on-a-paper feeding unit 80 according to the fifth embodiment is changed to a data-on-a-toner-image feeding unit 85. In other words, as shown in FIG. 17, the LED array control unit 34 has a data-on-a-toner-image feeding unit 85 provided externally. The data-on-a-toner-image feeding unit 85 reads out a toner image formed on an image-carrying substance (e.g. a photoreceptor 5) by the image forming apparatus, reflected in a fluctuation of image quality due to ageing, and feeds toner image data mainly representing the degree of uneven density of the toner image to the driving-current-correction-data calculation unit 39. The data-on-a-toner-image feeding unit 85 has an image sensor 86 applied thereto that scans and reads out a toner image formed on an image-carrying substance. The image sensor 86 is so mounted as to be in close proximity to a photoreceptor 5, facing to it, between each of developing units 4 and each of image transfer rollers 9 (See FIG. 1.) when the image-carrying substance is a photoreceptor 5.

According to the seventh embodiment, the driving-current-correction-data calculation unit 39 is connected to the characteristic-data memory unit 35 and to the data-on-a-toner-image feeding unit 85, reads out characteristic data memorized in the characteristic-data memory unit 35, receives data on a toner image fed from the data-on-a-toner-image feeding unit 85, calculates operating current correction data P for each of a plurality of the LED elements forming an LED array 31 based on the characteristic data, and increases or decreases the driving current correction data P in accordance with the data on a toner image in accordance with a predetermined calculation formula. Then, the calculated and increased/decreased driving current correction data P are fed to the image-data correction calculation unit 44. A procedure for lighting control of the LED elements is satisfied by receiving data on a toner image in place of data on an image on a paper in the step S402 in FIG. 14.

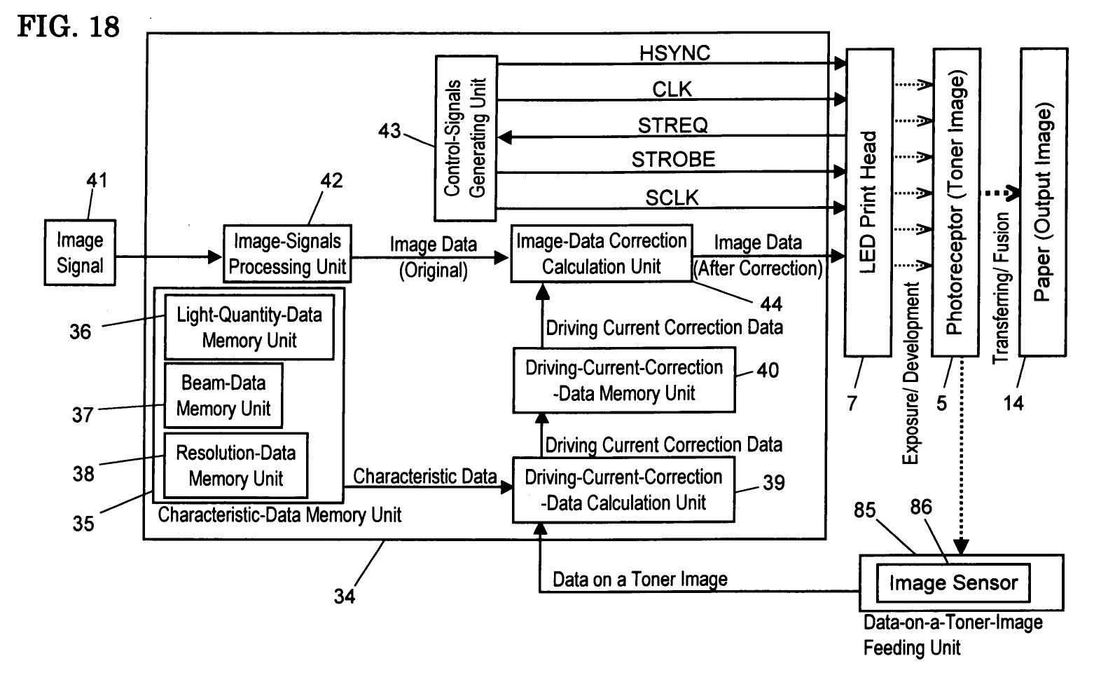

The same as the fifth embodiment, the seventh embodiment of the present invention is so constructed as to have driving current correction data P directly fed to an image-data correction calculation unit 44 after the driving current correction data P are calculated and increased/decreased in the driving-current-correction-data calculation unit 39. However, according to an eight embodiment of the present invention, the same as the relationship between the fifth and the sixth embodiments, as shown in FIG. 18, a driving-current-correction-data memory unit 40 is provided separately, that memorizes the driving current correction data P calculated and increased/decreased in the driving-current-correction-data calculation unit 39, and the driving-current-correction-data memory unit 40 is connected to the driving-current-correction-data calculation unit 39 and to the image-data correction calculation unit 44. According to the eight embodiment, a procedure for lighting control of the LED elements is satisfied by receiving data on a toner image in place of data on an image formed on a paper in the step S501 in FIG. 16.

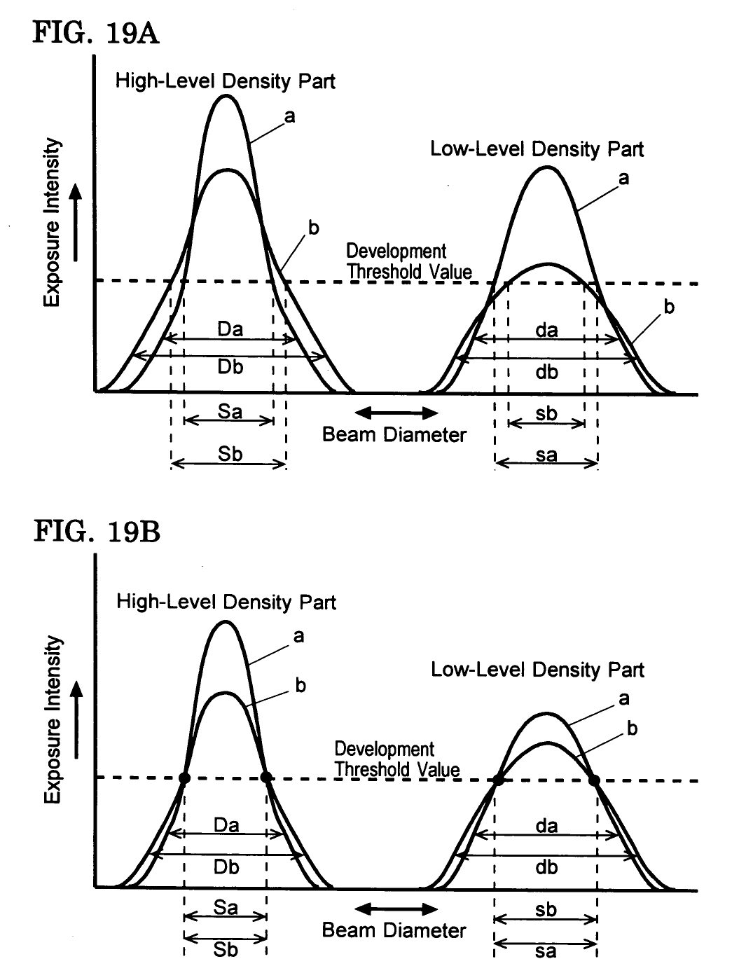

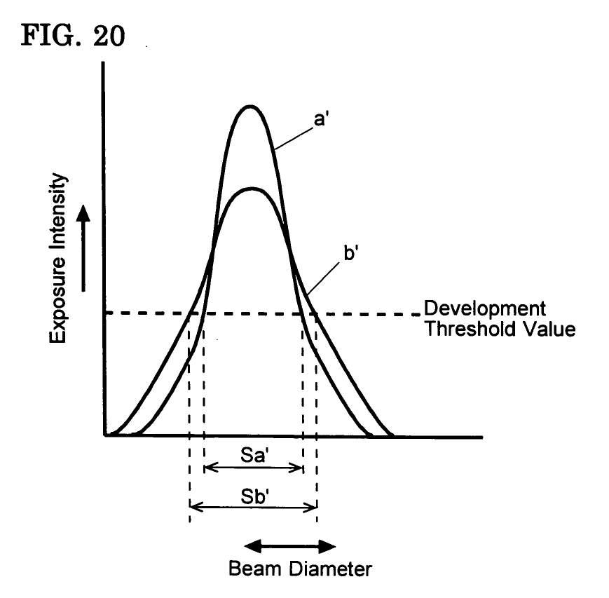

FIG. 19A and 19B show the relationship between the exposure intensity of the LED elements and the beam diameter in the development threshold value. Here, FIG. 19A shows the relationship between the exposure intensity of the LED elements and the beam diameter in the development threshold value before image data are corrected, while FIG. 19B shows the relationship between the exposure intensity of the LED elements and the beam diameter in the development threshold value after image data are corrected. As shown in FIG. 19A, either in a high-level density part or in a low-level density part, an LED element “a” and an LED element “b” have approximately the same quantity of light emitted (the peak area in the figure), but the beam diameter differs. (Generally, the beam diameter is specified within the range of 13.5% of the peak light quantity.) In other words, in either high-level or low-level density part, the LDE element “b” has a larger beam diameter than the LED “a.” (D_{b}>Dₐ and d_{b}>dₐ)

However, as shown in FIG. 19A, in the high-level density part, the dot diameter S_{b} in the development threshold value of the LED element “b” is larger than the dot diameter Sₐ of the LED element “a.” On the other hand, in the low-level density part, contrary to the high-level density part, the dot diameter sa in the development threshold value of the LED element “a” is larger than the dot diameter S_{b} of the LED element “b.” In other words, the size relationship of the dot diameters in the development threshold value between the LED element “a” and the LED element “b” does not depend on the size relationship of the above beam diameters, but depends on indication density of the LED elements. Therefore, under these circumstances, in the high-level density part, the LED element “b” having a larger dot diameter in the development threshold value has larger dots of a latent image, while in the low-level density part, the LED element “a” having a larger dot diameter in the development threshold value has larger dots of a latent image, and as a result, both will be expressed in dark in images.

Therefore, beam diameters of the LED element “a” and the LED element “b” in each level of indication density parts are memorized as characteristic data in advance, and correction data are made for driving current by using characteristic data concerning the beam diameters, thus canceling the difference in contrast of the indication density of the LED element “a” and the LED element “b” in each level of indication density parts.

In other words, as shown in FIG. 19B, driving current correction data are made by using characteristic data concerning the beam diameters in such a manner as, in the high-level density part, driving current of the LED element “b” having a large beam diameter (and a large dot diameter) is decreased and driving current of the LED element “a” having a small beam diameter (and a small dot diameter) is increased; while driving current correction data are made by using characteristic data concerning the beam diameters in such a manner as, in the low-level density part, driving current of the LED element “b” having a large beam diameter (but a small dot diameter) is increased and driving current of the LED element “a” having a small diameter (but a large dot diameter) is decreased. By making driving current correction data in the above-mentioned ways, the dot diameters of the LED element “a” and the LED element “b” in the development threshold value in each level of indication density parts will be the same. As a result, it is possible to cancel the difference in contrast of indication density of the LED element “a” and the LED element “b” in each level of the indication density parts.

FIG. 19A and 19B shows a case where driving current correction data are made by using beam diameters as characteristic data of the LED elements. However, as mentioned above, it is also possible to make driving current correction data by using as characteristic data, light quantity data of each of the LED elements, data on beam area and data showing resolution such as MTF data and the like, individually or combining a plurality of data thereof.

As a result, according to each of the above-mentioned embodiments, each individual LED element forming an LED array 31 has a characteristic-data memory unit 35 mounted thereon for memorizing a plurality of characteristic data that are measured in advance and that are contributing factors to occurrence of uneven density of images, and also has the following mounted thereon, including: a selective-information-data feeding unit 60 which feeds information data corresponding to selective information that is selected from the inherent selective information and is affecting image quality; a detected-data feeding unit 70 that feeds detected data on a change due to ageing affecting a fluctuation of image quality due to ageing; a data-on-a-image-on-a-paper feeding unit 80 that reads out an image formed on an output paper 14 reflected in a fluctuation of image quality due to ageing and feeds data of an image formed on a paper thereof; and a data-on-a-toner-image feeding unit 85 that reads a toner image formed on an image-carrying substance such as a photoreceptor 5 and the like and feeds data on a toner image thereof.

The driving-current-correction-data calculation unit 39 reads out characteristic data memorized in the characteristic-data memory unit 35 and receives information data fed from the selective-information-data feeding unit 60, detected data fed from the detected-data feeding unit 70, or data on an image formed on a paper fed from the data-on-an-image-on-a-paper feeding unit 80 and data on a toner image fed from the data-on-a-toner-image feeding unit 85. Then, the driving-current-correction-data calculation unit 39 calculates driving current correction data P concerning each individual LED element forming the LED array 31 based on characteristic data and information data, calculates driving current correction data P concerning each individual LED element based on characteristic data, and increases or decreases the driving current correction data P in accordance with the detected data or data on an image formed on a paper or data on a toner image. The driving current correction data calculation unit 39 is so constructed as to have driving current based on the driving current correction data P flow to the LED elements forming the LED array 31. As a result, the difference in contrast of indication density among the LED elements can be cancelled with a good precision, restraining uneven density of images. Consequently, it is possible to reduce occurrence of vertical streaks on images efficiently.

Additionally, according to each of the above-mentioned embodiments, the characteristic data memory unit 35 is so constructed as to have a transferable PROM used therein. Therefore, even when a change occurs in properties of each individual LED element, it is possible to transfer characteristic data for each of the LED elements smoothly. As a result, since it is possible to calculate driving current correction data for each of the LED elements with a good precision in calculating driving current correction data P, it is possible to correct image data with high precision.

According to each of the above-mentioned embodiments, the photoreceptor is shaped in a drum. However, the photoreceptor is not limited to being drum-shaped, but for example, a belt-shaped photoreceptor may be used. Moreover, an image-carrying substance is not limited to the photoreceptor 5. For example, an image forming apparatus adopting a two-stage image-transferring method, wherein a toner image formed on the photoreceptor 5 is once transferred to a transport belt 8 in each of an image forming apparatus according to the above embodiments and then the transferred toner image is re-transferred to a paper 14, may have the transport belt 8 be an image-carrying substance.

Also, according to each of the above-mentioned embodiments, an image forming apparatus is so constructed as to obtain color images in accordance with images of toners in black, yellow, cyan and magenta. The present invention may be applicable to a color image forming apparatus employing more than two colors of toners having different colors from each other.

While there have been described herein what are to be considered preferred embodiments of the present invention, various decorations and deformations to the present invention are possible to be practiced, provided all such modifications fall in the spirit and scope of invention.

What is claimed is:

1. An image forming apparatus comprising:
an LED print head comprising an LED array composed of a plurality of LED elements whose lighting is controlled according to image data and a driving circuit for driving the plurality of LED elements; and
an LED array controller for controlling driving of the LED print head,
wherein the image forming apparatus further comprises:
a selective-information data feeder for storing information data corresponding to different sets of selective information inherent to the image forming apparatus and for feeding out information data corresponding to a selected item of the selective information, and
wherein the LED array controller comprises:
a characteristic data memory for storing a plurality of sets of characteristic data each relating to one of the plurality of LED elements; and
a driving current correction data calculator for reading out the characteristic data from the characteristic data memory while receiving the information data from the selective-information data feeder in order to calculate, based on the characteristic data and the information data, driving current correction data for each of the plurality of LED elements.

2. An image forming apparatus comprising:
an LED print head comprising an LED array composed of a plurality of LED elements whose lighting is controlled according to image data and a driving circuit for driving the plurality of LED elements; and
an LED array controller for controlling driving of the LED print head,
wherein the image forming apparatus further comprises:
a selective-information data feeder for storing information data corresponding to different sets of selective information inherent to the image forming apparatus and for feeding out information data corresponding to a selected item of the selective information, and
wherein the LED array controller comprises:
a characteristic data memory for storing a plurality of sets of characteristic data each relating to one of the plurality of LED elements;
a driving current correction data calculator for reading out the characteristic data from the characteristic data memory while receiving the information data from the selective-information data feeder in order to calculate, based on the characteristic data and the information data, driving current correction data for each of the plurality of LED elements; and
a driving current correction data memory for reading out the driving current correction data from the driving current correction data calculator and for storing the driving current correction data thus read out.

3. An image forming apparatus as claimed in claim 1,
wherein the different sets of selective information correspond to a plurality of screens with different characteristics.

4. An image forming apparatus as claimed in claim 1,
wherein the different sets of selective information correspond to a plurality of toner colors.

5. An image forming apparatus comprising:
an LED print head comprising an LED array composed of a plurality of LED elements whose lighting is controlled according to image data and a driving circuit for driving the plurality of LED elements; and
an LED array controller for controlling driving of the LED print head,
wherein the image forming apparatus further comprises:
a detected data feeder for detecting time-related variation in the image forming apparatus in order to feed out detected data, and
wherein the LED array controller comprises:
a characteristic data memory for storing a plurality of sets of characteristic data each relating to one of the plurality of LED elements; and
a driving current correction data calculator for reading out the characteristic data from the characteristic data memory while receiving the detected data from the detected data feeder in order to calculate, based on the characteristic data, driving current correction data for each of the plurality of LED elements and increase or decrease the driving current correction data according to the detected data.

6. An image forming apparatus comprising:
an LED print head comprising an LED array composed of a plurality of LED elements whose lighting is controlled according to image data and a driving circuit for driving the plurality of LED elements; and
an LED array controller for controlling driving of the LED print head,
wherein the image forming apparatus further comprises:
a detected data feeder for detecting time-related variation in the image forming apparatus in order to feed out detected data, and
wherein the LED array controller comprises:
a characteristic data memory for storing a plurality of sets of characteristic data each relating to one of the plurality of LED elements;
a driving current correction data calculator for reading out the characteristic data from the characteristic data memory while receiving the detected data from the detected data feeder in order to calculate, based on the characteristic data, driving current correction data for each of the plurality of LED elements and increase or decrease the driving current correction data according to the detected data; and
a driving current correction data memory for reading out the driving current correction data calculated and increased or decreased by the driving current correction data calculator and for storing the driving current correction data thus read out.

7. An image forming apparatus as claimed in claim 5,
wherein the detected data feeder detects atmospheric temperature inside the image forming apparatus and feeds out the temperature as the detected data.

8. An image forming apparatus as claimed in claim 5,
wherein the detected data feeder detects humidity inside the image forming apparatus and feeds out the humidity as the detected data.

9. An image forming apparatus as claimed in claim 5,
wherein the detected data feeder detects number of sheets of paper on which the image forming apparatus has formed an image and feeds out the number as the detected data.

10. An image forming apparatus as claimed in claim 5,
wherein the detected data feeder detects a developing bias potential in the image forming apparatus and feeds out the voltage as the detected data.

11. An image forming apparatus as claimed in claim 5,
wherein the detected data feeder detects a dark potential and a light potential in the image forming apparatus and feeds out the dark potential and the light potential as the detected data.

12. An image forming apparatus comprising:
an LED print head comprising an LED array composed of a plurality of LED elements whose lighting is controlled according to image data and a driving circuit for driving the plurality of LED elements; and
an LED array controller for controlling driving of the LED print head,
wherein the image forming apparatus further comprises:
a paper image data feeder for reading an image formed by the image forming apparatus on a sheet of paper output therefrom in order to feed out paper image data, and
wherein the LED array controller comprises:
a characteristic data memory for storing a plurality of sets of characteristic data each relating to one of the plurality of LED elements;
a driving current correction data calculator for reading out the characteristic data from the characteristic data memory while receiving the paper image data from the paper image data feeder in order to calculate, based on the characteristic data, driving current correction data for each of the plurality of LED elements and increase or decrease the driving current correction data according to the paper image data.

13. An image forming apparatus as claimed in claim 12,
wherein the paper image data feeder includes an image sensor for reading the image formed on the sheet of paper output from the image forming apparatus.

14. An image forming apparatus comprising:
an LED print head comprising an LED array composed of a plurality of LED elements whose lighting is controlled according to image data and a driving circuit for driving the plurality of LED elements; and
an LED array controller for controlling driving of the LED print head,
wherein the image forming apparatus further comprises:
a toner image data feeder for reading a toner image formed on an image-carrying member by the image forming apparatus in order to feed out toner image data, and
wherein the LED array controller comprises:
a characteristic data memory for storing a plurality of sets of characteristic data each relating to one of the plurality of LED elements;
a driving current correction data calculator for reading out the characteristic data from the characteristic data memory while receiving the toner image data from the toner image data feeder in order to calculate, based on the characteristic data, driving current correction data for each of the plurality of LED elements and increase or decrease the driving current correction data according to the toner image data.

15. An image forming apparatus as claimed in claim 14,
wherein the image-carrying member is a photoconductor or a transport belt.

16. An image forming apparatus as claimed in claim 14,
wherein the toner data feeder includes an image sensor for reading the toner image formed on the image-carrying member.

17. An image forming apparatus as claimed in claim 12,
wherein the LED array controller further comprises a driving current correction data memory for reading out the driving current correction data calculated and increased or decreased by the driving current correction data calculator and for storing the driving current correction data thus read out.
